(19) United States
(12) Patent Application Publication
(10) Pub. No.: US 2025/0286718 A1
(43) Pub. Date: Sep. 11, 2025

(54) NETWORKED SYSTEM FOR PRIVATE ASSET MANAGEMENT ACROSS ON CHAIN AND OFF CHAIN MACHINES

(71) Applicant: Hamsa Pay, Inc., San Francisco, CA (US)

(72) Inventors: Hongbing WU, San Francisco, CA (US); Adam ZBAR, San Francisco, CA (US); Wenhao LIN, San Francisco, CA (US); Chen SUN, San Francisco, CA (US)

(21) Appl. No.: 18/797,264

(22) Filed: Aug. 7, 2024

Related U.S. Application Data
(60) Provisional application No. 63/550,966, filed on Feb. 7, 2024.

(51) Int. Cl. H04L 9/32; H04L 9/00

(52) U.S. Cl. CPC H04L 9/3221; H04L 9/50

(57) ABSTRACT

A system has off chain transaction confirmation machines exchanging private transaction messages. Off chain zero knowledge proof machines are in communication with the off chain transaction confirmation machines. Off chain bank machines are in communication with the zero knowledge proof machines via proprietary code associated with the off chain zero knowledge proof machines. Off chain central bank machines are in communication with the off chain bank machines to validate a network transaction and form a private network transaction record and a public network transaction record. On chain bank machines and on chain central bank machines record the public network transaction record in a distributed ledger.

### CROSS-REFERENCE TO RELATED APPLICATION

This application claims priority to U.S. Provisional Patent Application 63/550,966, filed Feb. 7, 2024, the contents of which are incorporated herein by reference.

### FIELD OF THE INVENTION

This invention relates generally to authorizing transactions in computer networks. More particularly, the invention is directed to a networked system for private asset management across on chain and off chain machines.

### BACKGROUND OF THE INVENTION

A distributed ledger (also referred to as a blockchain) is a decentralized collection of machines that operate in a public manner to record transactions permanently and incorruptibly. Machines implementing the distributed ledger are commonly referred to as “on chain” machines since they operate on a blockchain. “Off chain” machines record private transactions that are not accessible to the public.

On chain transactions within a distributed ledger are growing in popularity. While users appreciate the attributes of a distributed ledger, there is a need to execute transactions without all the transaction details available to the public. In other words, there is a need for a networked system for private asset management across on chain and off chain machines.

### SUMMARY OF THE INVENTION

A system has off chain transaction confirmation machines exchanging private transaction messages. Off chain zero knowledge proof machines are in communication with the off chain transaction confirmation machines. Off chain bank machines are in communication with the zero knowledge proof machines via proprietary code associated with the off chain zero knowledge proof machines. Off chain central bank machines are in communication with the off chain bank machines to validate a network transaction and form a private network transaction record and a public network transaction record. On chain bank machines and on chain central bank machines record the public network transaction record in a distributed ledger.

### BRIEF DESCRIPTION OF THE FIGURES

The invention is more fully appreciated in connection with the following detailed description taken in conjunction with the accompanying drawings, in which:

FIG. 1 illustrates networked machines utilized in accordance with an embodiment of the invention.

FIG. 2 illustrates processing of tokenized Federal Public Securities (TPFt) contracts in accordance with an embodiment of the invention.

FIG. 3 illustrates customer interactions with the system of FIG. 2.

FIG. 4 illustrates a smart contract pool utilized in accordance with an embodiment of the invention.

FIG. 5 on chain and off chain operations performed in accordance with an embodiment of the invention.

FIG. 6 illustrates tokenized deposit processing performed in accordance with an embodiment of the invention.

FIG. 7 illustrates bank account creation in accordance with an embodiment of the invention.

FIG. 8 illustrates bank account settlement between two banks in accordance with an embodiment of the invention.

FIG. 9 illustrates off chain resources utilized in accordance with an embodiment of the invention.

FIG. 10 illustrates distributed off chain resources utilized in accordance with an embodiment of the invention.

FIG. 11 illustrates on chain and off chain operations performed in accordance with an embodiment of the invention.

FIG. 12 illustrates Centralized Bank Digital Currency (CBDC) processing performed by a first bank in accordance with an embodiment of the invention.

FIG. 13 illustrates CBDC processing performed by a second bank in accordance with an embodiment of the invention.

FIG. 14 illustrates token processing between users utilizing two different banks.

FIG. 15 illustrates tokenized federal treasury bond processing performed in accordance with an embodiment of the invention.

Like reference numerals refer to corresponding parts throughout the several views of the drawings.

### DETAILED DESCRIPTION OF THE INVENTION

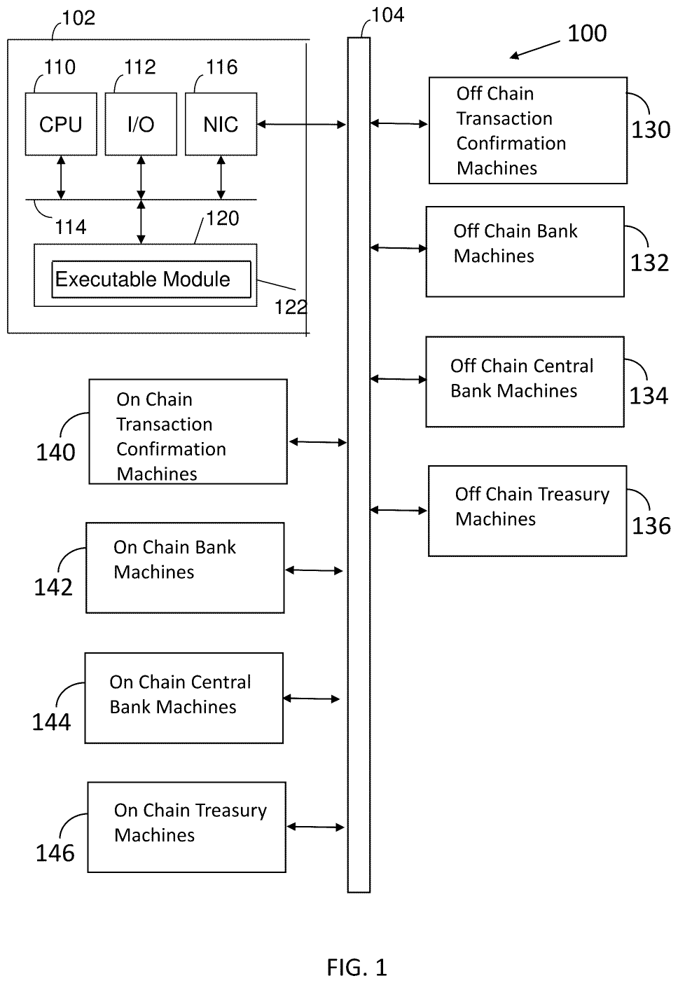

FIG. 1 illustrates a system 100 with a collection of machines to implement operations disclosed herein. Machine 102 is exemplary. Machine 102 has a processor 110 connected to input/output devices 112 via a bus 114. A network interface circuit 116 is also connected to the bus 114 to provide connectivity to network 104, which may be any collection of wired and wireless networks. A memory 120 is also connected to the bus 114. The memory stores an executable module 122 with instructions executed by processor 110 to implement operations specified by the instructions.

System 100 includes off chain transaction confirmation machine 130. These machines are distributed cloud resources. The system 100 also includes off chain bank machines 132, off chain central bank machines 134 and off chain treasury machines 136. The system 100 also includes similar on chain resources, including on chain transaction confirmation machines 140, on chain bank machines 142, on chain central bank machines 144 and on chain treasury machines 146.

The off chain transaction confirmation machines 130 provide a privacy and security solution for network transactions on a distributed ledger or blockchain. An embodiment of the invention will be disclosed in the context of an Ethereum Virtual Machine (EVM) compatible blockchain. By using the solution, it is also easy to build a permission orchestration structure. A use case is creating a privacy and security solution for whole and retail payments and trading where (i) a bank can view all transactions for their bank, (ii) two banks can view transactions between them, (iii) the central bank can monitor all private transactions between banks, and (iv) no other parties can see the private transactions.

Embodiments of the invention address several key requirements, including:
Privacy compliance
   Balances of tokens must be known only by the wallet and the Central Bank.
   Transactions on the platform should be anonymous and no one except sender, receiver, and the Central Bank should identify that a transaction occurred between two institutions.
   The value involved in a transaction must be known only by the sender, receiver, and the Central Bank.
Level of programmability available with privacy of balances and transactions.
Capability of reusing protocols implemented for the public Ethereum network (EVM Compatible).
Support different private transactions by using Zero Knowledge Proofs (ZKP), smart contracts, and Circom (a compiler for compiling circuits written in the Circom language. The compiler outputs the representation of the circuit as constraints, and everything needed to compute different ZKP) and smart contracts.)
Interoperability with on chain applications such as DeFi and off-chain applications such as off chain payment (example: Pix in Brazil), open finance, etc.
Decentralized solution with decentralized nodes, not a centralized node.
EVM smart contracts running on nodes for existing smart contracts support.
CBDC: wholesale currency provided by the central bank (e.g., ERC20 token). CBDC is an acronym for Central Bank Digital Currency.
DVt: tokenized deposit of a bank (e.g., ERC20 token).
DVt_A: tokenized deposit of Bank A (e.g., ERC20 token).
DVt_B: tokenized deposit of Bank B (e.g., ERC20 token).
TPFt: tokenized federal treasury bond (e.g., ERC1155 or ERC20 token).
DvP: delivery versus payment.
ZKP: zero-knowledge proof.
EVM: The Ethereum Virtual Machine (EVM) is a decentralized computing environment that enables the execution of smart contracts.
Node: a ZKP server can store privacy data and enable roll-up function and support EVM compatible smart contract running.
Circom: a domain-specific language (DSL) for defining arithmetic circuits, which are used in zero-knowledge proofs (ZKPs).
Smart Contract: digital contracts that automatically enforce and execute the terms of an agreement when predefined conditions are met.
Smart Contract Pool: an on chain smart contract pool associated with an off chain ZKP server, used to store private data on chain by using ZKP technology.
Pix: an instant payment system launched by the Central Bank of Brazil in November 2020.
Open Finance: an extension of the Open Banking initiative that broadens the scope to include a wider range of financial products and services beyond traditional banking.

Consider the following use cases:
1) Payment between two banks using CBDC.
2) TPFt trade between two banks using CBDC.
3) Payment between two customers in two banks using CBDC and DVt.
4) TPFt trade between two customers in two banks using CBDC and DVt.

Case 1 and 3 show how to move money between two parties. Case 2 and 4 give examples on how to trade TPFt by using CBDC and DVt as payment currencies.

User case 1 is to provide privacy and confidentiality for payment between two banks with CBDC. The use case that we would like to implement is bank A transfers CBDC to bank B. In this case, only two different institutions will be involved, and the payment will be with CBDC.

User case 2 is to provide privacy and confidentiality for DvP between TPFt and CBDC. The use case that we would like to implement is the purchase of TPFt by a bank. In this case, only two different banks will be involved, and the purchase will be with CBDC. Below is a brief description of the use case:

1. Bank A uses CBDC to buy TPFt from Bank B. The offering of securities is made in an off chain environment.

2. Bank A sends a transaction with the negotiated data (operationId; address sender; address receiver; caller part; tokenid; TPFt amount; unitPrice; timestamp; operationStatus) Bank B sends a transaction with the same data. The order of execution is not determined.

3. After receiving both transactions, if the data is correct, that is, if there is a match, TPFt is transferred to Bank A and the CBDC is transferred to Bank B.

4. Only Bank A, Bank B and the Central Bank can see the values traded and the transaction carried out. For other participants, the data will not be visible.

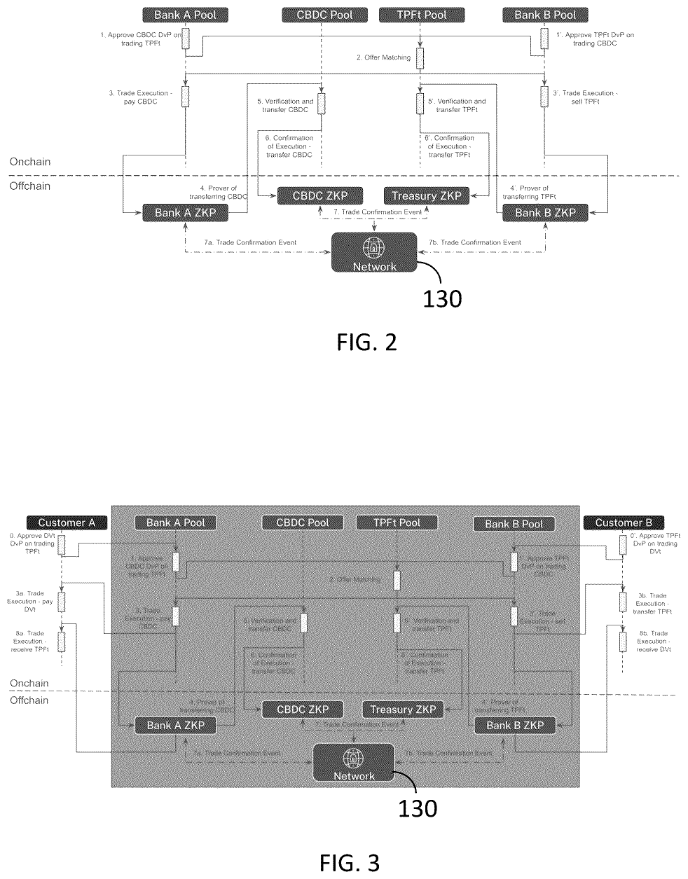

No participant can see the other's balance on layer 1 and no transaction information The details of the transaction are shown in FIG. 2. The on chain resources include a Bank A Pool, a CBDC Pool, a TPFt Pool and a Bank B Pool. The off chain resources include a Bank A ZKP machine, a CBDC ZKP machine a treasury ZKP machine, a Bank B ZKP machine and a network 130 corresponding to the off chain transaction confirmation machines.

User case 3 is to provide privacy and confidentiality for payment between two customers in two banks by CBDC and DVt. Customer A at bank A makes a payment to client B in bank B.

1. Customer A uses a DVt_A from Bank A to pay customer B from Bank B.

2. Bank A burns DVt_A, Bank A sends a CBDC to Bank B, and Bank B mints DVt_B which is provided to participant B.

3. Only Customer A, Customer B, Bank A, Bank B, and the Central Bank can see the values traded and the transaction carried out. For other participants, the data will not be visible. No participant can see the other's balance on layer 1, and no transaction information.

User case 4 provides privacy and confidentiality for DvP between TPFt, CBDC and DVt. Customers from 2 different banks buy/sell TPFt using DVt and CBDC.

1. Customer A uses DVt_A from Bank A to buy TPFt from customer B from Bank B. The offering of securities is made in an off-chain environment. As shown in FIG. 3, network 130 is used to coordinate these off-chain operations.

2. Customer A sends a transaction with the negotiated data (operationId; address sender; address receiver; caller part; tokenid; TPFt amount; unitPrice; timestamp; operationStatus). Customer B sends a transaction with the same data. The order of execution is not determined.

3. After receiving both transactions, if the data is correct, that is, if there is a match, TPFt is transferred to participant A, Bank A burns DVt_A, Bank A sends a CBDC to Bank B, and Bank B mints DVt_B, which is provided to participant B.

4. Only Customer A, Customer B, Bank A, Bank B and the Central Bank can see the values traded and the transaction carried out. For other participants, the data is not visible.

The disclosed solution meets the privacy and security requirements for financial applications by using a Smart Contract Pool and ZKP server. FIG. 3 illustrates off chain network 130 in communication with ZKP servers, which interface with on chain servers. The solution combines the ZKP technology and a Smart Contract Pool to keep the account, balance, and transaction information private and secure.

The solution also meets the interoperability, permission orchestration and throughput requirements. The interoperability capability reduces the complexity and cost of transactions between different systems. The Smart Contract Pool allows one to specify the permission orchestration structure for a applications. For example, the central bank may monitor all private transactions between two banks.

The ZKP technology and smart contract pool keep the account, balance and transaction information private and secure. Account, balance and transactions in a pool can not be seen by others.
Central bank has its own pool
a. In the pool there is CBDC.
b. Each bank has one settlement account in the pool.
c. CBDC balance and transactions are inside the pool, and it is private.
d. The CBDC is safe; only the account owner can access the money.
e. Central bank has the ZKP server and can monitor all accounts and transactions in the pool.
Each bank has its own pool
a. In the pool there are DVt.
b. Each client of the bank has a balance account.
c. DVt balance and transactions are inside the pool and it is private.
d. The DVt is safe; only the account owner can access the money.
Event driven for transactions between pools.
a. Encrypt the event information to keep private.
b. Events can be seen by the Central Bank.

Those skilled in the art will recognize key benefits associated with the disclosed solution:
1. Similar with the current banking system
   a. Orchestration of the pool hierarchy meets legal requirements.
   b. Each bank has its own ZKP server and can connect to their legacy system and be compatible with their current systems.
2. EVM compatible
   a. Smart contracts for the pool are EVM compatible.
   b. Easy to add more functionalities upon requirements.
3. ZKP feature keeps data private
   a. Each pool has its own ZKP server, ensuring privacy.
   b. Central bank can monitor and control CBDC transactions within its own pool.
4. ZKP roll-up to enhance throughputs
   a. Roll-up transactions can give higher transaction throughputs.
5. Recorded events for audit
   a. Events between pools are recorded and cannot be deleted.
   b. Events can be monitored by the Central Bank.

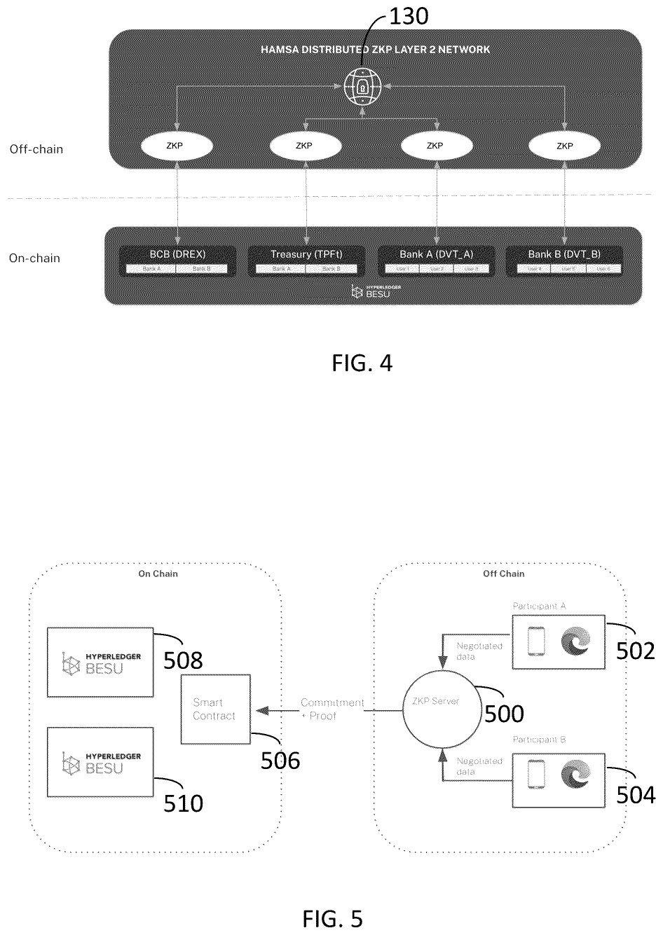

FIG. 5 illustrates off chain ZKP server 500 receiving information from participant A machine 502 and participant B machine 504 to produce a commitment and proof, which is conveyed to on chain machines including a smart contract machine 506 and block chain machines 508 and 510.

In one embodiment, Web3 Zero-Knowledge Proof technology is used. Zero-knowledge proofs (ZKPs) are a cryptographic technique that allows one party (the prover) to prove to another party (the verifier) that a statement is true without revealing underlying information.

For each type of token, the smart contract pool keeps balance for an account (CL, CR):

CL=g\hat{ }b*y\hat{ }r,CR=g\hat{ }r

When withdrawn or deposited, we post (g\hat{ }deta_b*y\hat{ }delta_r, g\hat{ }delta_r) to a smart contract. Balance is updated as:

CL′=g\hat{ }(b+delta_b)*y\hat{ }(r+delta_r),CR′=g\hat{ }(r+delta_r)

Account owner only can access:

g\hat{ }b=CL/(CR\hat{ }X).X is the private key.

### Privacy Protection

Zero-knowledge proofs can be used to verify an individual's identity, without revealing any sensitive personal information.
Instead of supplying identity details, users can simply verify that they meet certain criteria—such as a decentralized identity that verifies that they are a citizen of a country without having to share their name or passport number.

ZKP-based identity protocols can give individuals more control over their personal data.

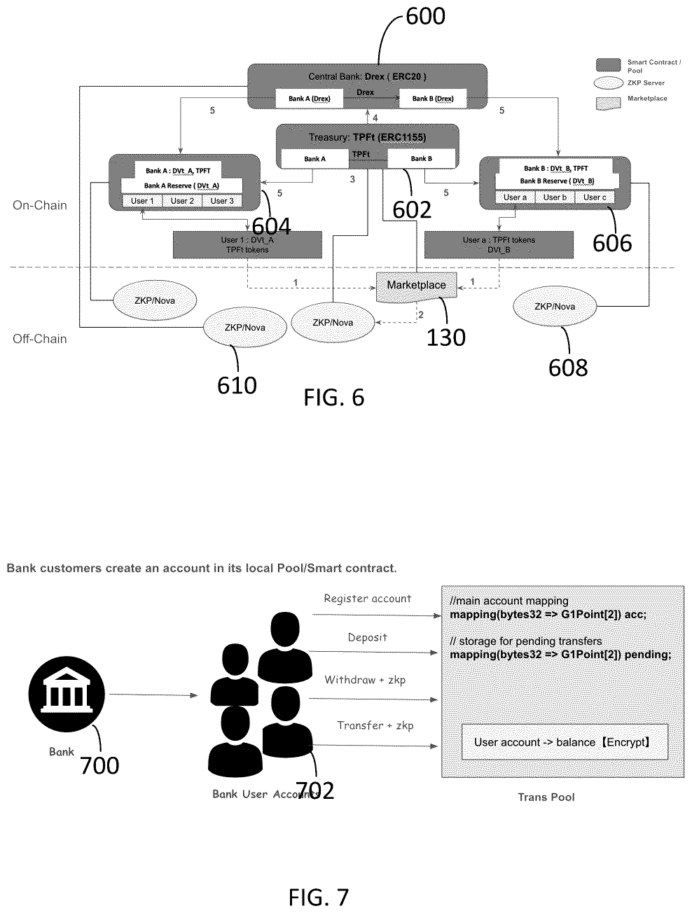

FIG. 6 illustrates a central bank machine 600 in communication with a treasury machine 602, a first bank machine 604 and a second bank machine 606. These machines are on chain resources that administer a smart contract pool. Off chain resources include network 130 and different ZKP machines 608 and 610.

FIG. 7 illustrates a bank 700 serving user accounts 702. Each customer creates an account in its local smart contract pool. User actions include registering an account, making a deposit, making a withdrawal with a ZKP operation and transfer funds with a ZKP operation.

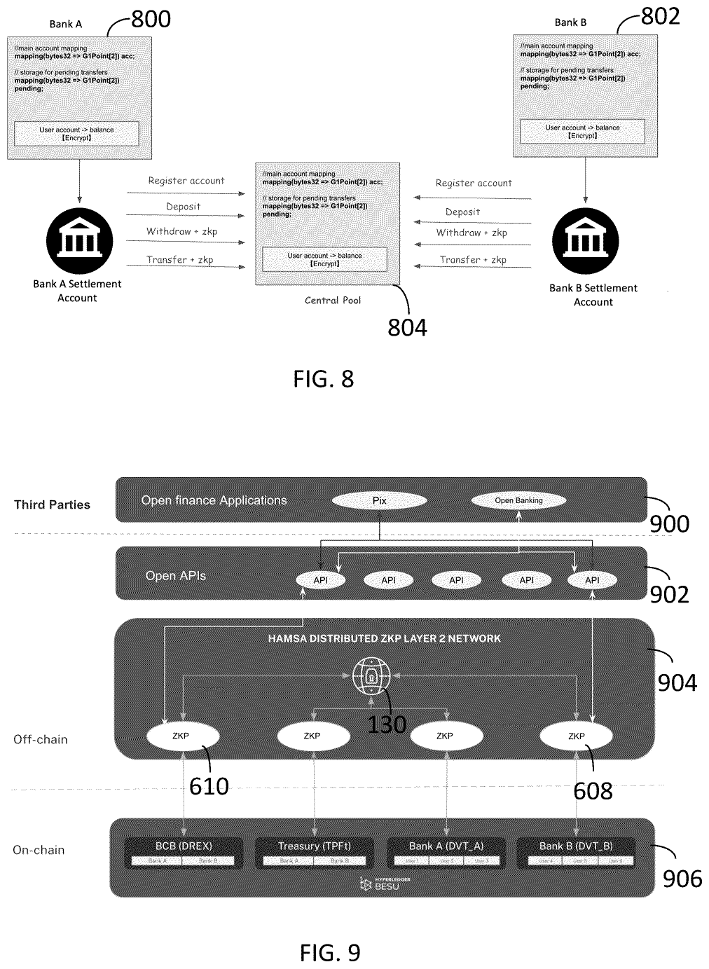

FIG. 8 illustrates a first bank 800 and a second bank 802 administering a smart contract view a smart contract pool 804. The operations are of the type discussed in connection with FIG. 7.

Transparency and privacy are two desirable qualities for any blockchain. However, the ability to openly track transactions while keeping personal details protected is not possible for all blockchains. To achieve these qualities, blockchains need privacy-centric proof systems.
Execute private transaction off-chain and generates a new state.
A proof is also generated to prove that the transaction is executed and the new state by executing the transaction is correct.
Submit new state and proof to the blockchain.
Blockchain verifies the correctness of proof and accepts the new state if proof is verified.

Apparently, the proof submitted to blockchain should not reveal any information about the transaction executed off-chain for privacy protection purposes that can be achieved by Zero-knowledge proof (ZKP) technology.

The most notable variant of ZKPs is zk-SNARK. Zk-SNARK is a type of cryptographic proof system.
Zero-Knowledge: No additional information, other than the validity of the statement is revealed. The verifier can confirm the statement's truth but gains no extra knowledge about the specific details of the statement.
Succinct: The proofs are designed to be small and require minimal compute resources to verify.
Non-interactive: Prover can send the proof to the verifier without any further communication or information exchange. This makes the proof system more efficient and practical.
Argument of Knowledge: Cryptographic assertion that the prover possesses specific information.

The disclosed solution supports different private transactions by using ZKP, Circom and smart contracts. Circom and smart contracts serve different purposes, we integrate them to handle sensitive data and computations securely and privately, to create powerful, privacy-preserving blockchain applications.

Using Circom, we define circuits that specify how inputs are processed to produce outputs. These circuits are essentially mathematical functions. The Circom compiler translates these high-level circuit definitions into low-level constraints that zk-SNARKs can use. With the compiled circuit, inputs are used to generate cryptographic proofs that attest to the validity of the computation without revealing the actual inputs. These proofs can be verified by anyone using a verification key, ensuring the integrity of the computation.

Zero-knowledge proofs can enhance the functionality and privacy of smart contracts. ZKPs allow users to prove knowledge of certain information without revealing the information itself. Circom can be used to define circuits that generate ZKPs for specific computations or conditions. Smart contracts can use these ZKPs to verify computations without having access to the actual data. For example, a smart contract can verify a proof that a user possesses a valid credential without seeing the credential itself.

The disclosed solution creates circuits, uses Circom to define and generate zero-knowledge proofs and smart contracts, and deploy the verification smart contracts on chain. Whenever there is a need for verification, the verification smart contracts will be called to do the verification without showing the credential information.

The disclosed solution provides the capability for integrating on chain applications such as DeFi with off chain applications such as off chain payment, open finance, etc.

Pix allows individuals and businesses to make and receive payments 24/7, including weekends and holidays, using a variety of identifiers, such as phone numbers, email addresses, or tax IDs.

Open Finance aims to create a more integrated and competitive financial ecosystem by enabling customers to share their financial data with third-party providers through secure and standardized APIs (Application Programming Interfaces). This can include data from various financial sectors such as investments, insurance, pensions, and savings accounts.

With the disclosed technology, the ZKP server is also an off chain node to store private data. The Open API layer can retrieve private data from the ZKP server based on data privacy controls. If a third-party application gets the permission to access some private data, it will call the APIs in the Open API layer, get private data from the ZKP server.

This scenario is characterized in FIG. 9. A third-party layer 900 includes applications that access an open API layer 902, which communicates with off-chain components 904, including network 130 and ZKP servers 608 and 610. The off chain components 904 interact with the on chain components 906.

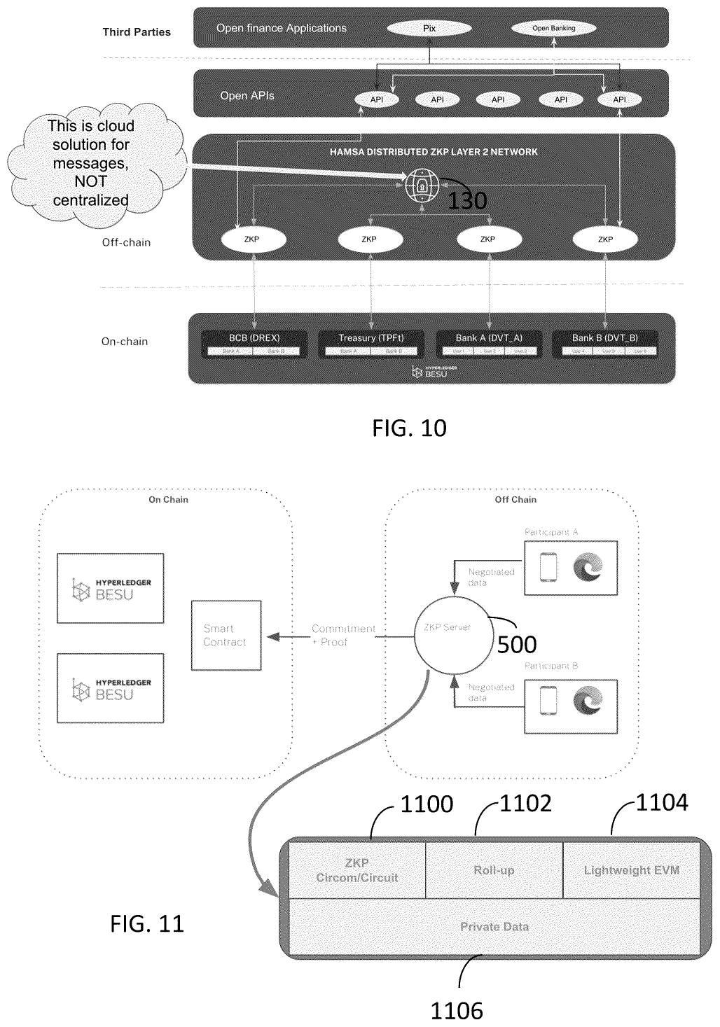

FIG. 10 corresponds to FIG. 9 but emphasizes the fact that network 130 is a de-centralized cloud solution. The on chain uses blockchain, it is decentralized. Off chain nodes are also decentralized nodes, not one centralized node. The off chain nodes use events to synchronize information between each other, so that a node can have information from another node and can reproduce, take over the job of the other node after it gets the permission.

To meet the privacy requirement, a node allows sending private messages to the transaction counter parties. Also, the central bank will receive those events for monitoring purposes. To achieve decentralized off chain nodes, 1) the disclosed technology includes providing these nodes with executable code to implement the operations disclosed herein; 2) executable code also provides access control in each node of network 130.

Enabling EVM smart contracts running on nodes is important, so that the node can support existing smart contracts. The node is a ZKP server, supporting privacy data and transaction roll-up functionality. In an embodiment of the disclosed solution, it also has the EVM smart contract running environment, so that the smart contracts can be run in the node. That enables the support of existing smart contracts.

If needed, privacy functions can be added to the smart contracts according to specified guidelines, such as adding verification proof before executing fund movement. Thereafter, the smart contract with privacy is not an ordinary Ethereum smart contract anymore, it is an Ethereum smart contract with privacy.

This scenario is depicted in FIG. 11, which corresponds to FIG. 5, but shows ZKP server 500 forming a smart contract with a ZKP circuit 1100, rolled up administrative information 1102, a lightweight Ethereum Virtual Machine (EVM) 1104 and private data 1106.

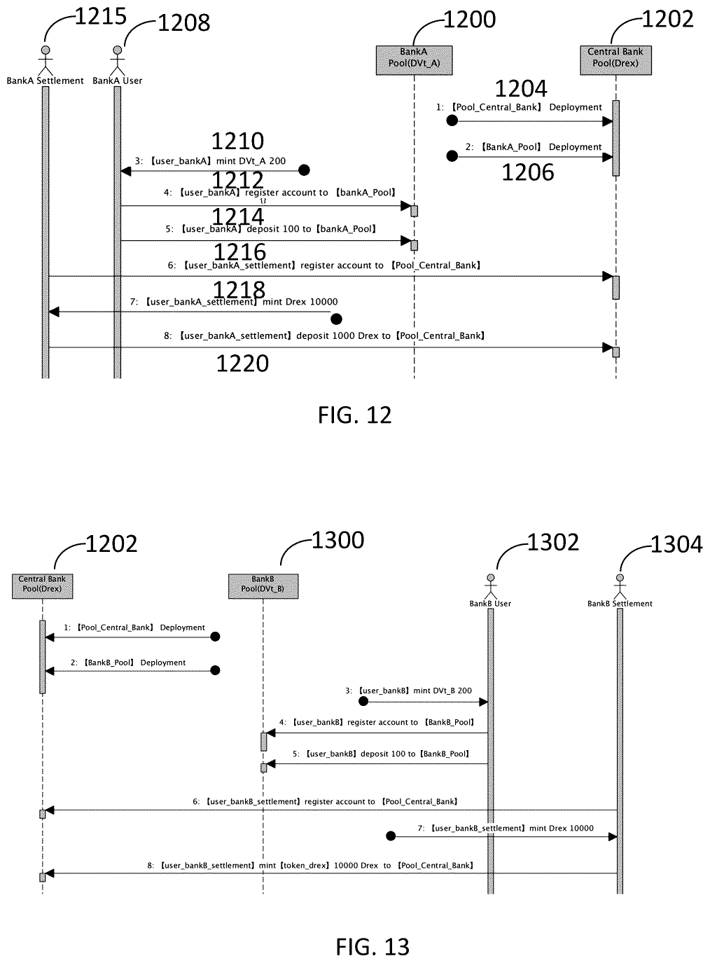

FIG. 12 illustrates operations between a first bank machine 1200 and a central bank machine 1202. Signals 1204 and 1206 represent a deployment or registration process. A user machine 1208 interacts with the bank 1200 when the bank mints DVt_A. User machine 1208 registers with signal 1212 and then makes a deposit via signal 1214. A settlement machine 1215 registers with central bank machine 1202 via signal 1216. The bank 1200 acknowledges the settlement via signal 1218. The deposit is completed via signal 1220.

FIG. 13 illustrates similar operations performed between central bank machine 1202 and a second bank 1300. Interactions with a second bank user machine 1302 and a second bank settlement machine 1304 are shown.

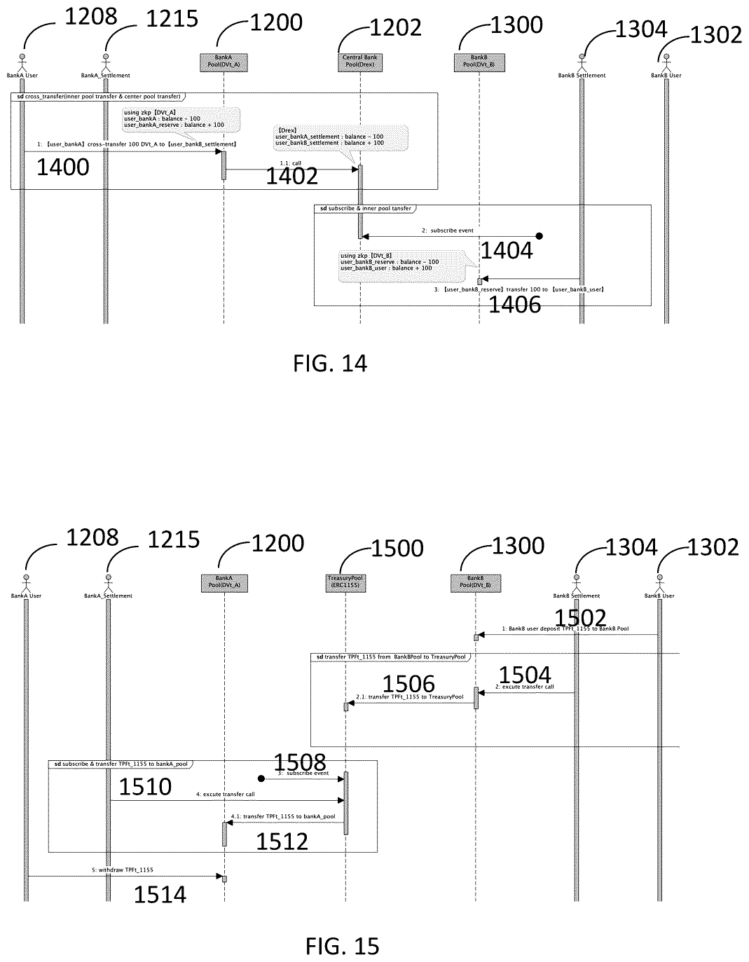

FIG. 14 illustrates the processing of a token between two banks via a central bank machine 1202. The processing involves first bank machine 1200, first bank user machine 1208 and first bank settlement machine 1215, second bank machine 1300, second bank user machine 1302 and second bank settlement machine 1304. First bank user machine 1208 initiates a transfer with signal 1400. First bank machine 1200 contacts the central bank machine 1204 to settle the transfer via signal 1402. The second bank settlement machine 1404 sends signal 1404 to access the event. Signal 1406 then completes the transfer at the second bank 1300.

A source code example follows. Arrows associated with the source code provide explanatory text.

FIG. 15 illustrates Tokenized federal treasury bond (TPFt) flow in accordance with an embodiment of the invention. A treasury pool machine 1500 operates in conjunction with first bank user machine 1208, first bank settlement machine 1215, first bank machine 1200, second bank machine 1300, second bank settlement machine 1304 and second bank user machine 1302. Second bank user machine 1302 makes a deposit at second bank machine 1300 via signal 1502. The second settlement bank machine 1304 initiates a transfer call signal 1504, which is relayed to the treasury pool machine 1500 via signal 1506. The first bank machine 1200 subscribes to the event via signal 1508 (it learned of the event via off chain network 130). A transfer call 1510 is initiated from the first settlement machine 1215. A transfer request 1512 is sent from treasury machine 1500 to first bank 1200. The first user machine 1208 sends a withdrawal signal 1514 to first bank 1200. These operations are more fully characterized with the following code.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include but are not limited to: magnetic media, optical media, magneto-optical media, and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using an object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A system, comprising:
off chain transaction confirmation machines exchanging private transaction messages;
off chain zero knowledge proof machines in communication with the off chain transaction confirmation machines;
off chain bank machines in communication with the zero knowledge proof machines via proprietary code associated with the off chain zero knowledge proof machines;
off chain central bank machines in communication with the off chain bank machines to validate a network transaction and form a private network transaction record and a public network transaction record; and
on chain bank machines and on chain central bank machines to record the public network transaction record in a distributed ledger.

2. The system of claim 1 wherein the private network transaction record is available to the off chain bank machines and off chain central bank machines.

3. The system of claim 1 wherein the on chain bank machines and on chain central bank machines administer a smart contract associated with the network transaction.

4. The system of claim 1 wherein the smart contract has a configurable permission orchestration structure.

5. The system of claim 1 wherein the off chain zero knowledge proof machines generate a commitment and proof from negotiated data received from a first off chain bank machine and a second off chain bank machine.

6. The system of claim 5 wherein the commitment and proof include a zero knowledge proof circuit and private data.

7. The system of claim 1 further comprising an application program interface to facilitate communications with the off chain zero knowledge proof machines and third-party applications.

8. The system of claim 1 wherein the off chain transaction confirmation machines are distributed machines in a cloud environment.

9. The system of claim 1 further comprising off chain treasury machines and on chain treasury machines to support tokenized federal treasury bond processing.
